(19) United States
(12) Patent Application Publication
(10) Pub. No.: US 2013/0287453 A1
(43) Pub. Date: Oct. 31, 2013

(54) DEVELOPING APPARATUS AND PROCESS CARTRIDGE

(71) Applicant: CANON KABUSHIKI KAISHA, Tokyo (JP)

(72) Inventors: Yoshihiro Mitsui, Numazu-shi (JP); Nobuyoshi Yoshida, Suntou-gun (JP); Kodai Hayashi, Suntou-gun (JP); Hisashi Taniguchi, Suntou-gun (JP)

(73) Assignee: Canon Kabushiki Kaisha, Tokyo (JP)

(21) Appl. No.: 13/862,761

(22) Filed: Apr. 15, 2013

(30) Foreign Application Priority Data
Apr. 26, 2012 (JP) 2012-101859

(51) Int. Cl. G03G 15/08

(52) U.S. Cl. CPC G03G 15/0812
USPC 399/284

(57) ABSTRACT

A developing apparatus, including: a developer carrying member; a developer feeding member configured to feed the developer to the developer carrying member in abutment with the developer carrying member; and a developer regulating member having a distal end portion directed toward an upstream side in a rotation direction of the developer carrying member, and configured to regulate a layer thickness of the developer on the developer carrying member in abutment with a surface thereof. Surfaces of the developer carrying member and the developer feeding member move in the same direction in an abutment portion. The distal end portion of the developer regulating member has a developer taking-in portion away from the surface of the developer carrying member toward the upstream side in the rotation direction. The developer taking-in portion is positioned upstream of an abutment position between the developer regulating member and the developer carrying member.

### BACKGROUND OF THE INVENTION

1. Field of the Invention

The present invention relates to a developing apparatus configured to develop an image with use of developer, a cartridge including the developing apparatus, and an image forming apparatus using the developing apparatus.

2. Description of the Related Art

Conventionally, as a developing apparatus configured to visualize an electrostatic latent image through use of one-component toner, there is known a developing apparatus including a developing roller serving as a developer carrying member configured to carry and convey toner, and a feed roller serving as a developer feeding member, arranged at a position on the periphery of the developing roller, configured to feed toner to the developing roller.

In the developing apparatus, toner is fed to the developing roller while becoming charged triboelectrically by mechanical rubbing between the feed roller and the developing roller. The fed toner has a toner layer thickness on the developing roller regulated to a predetermined amount by a developer regulating member, and thereafter, is conveyed to a developing region close to a photosensitive drum which is an electrostatic latent image bearing member, to thereby visualize an electrostatic latent image as a toner image.

The toner remaining on the developing roller without being used for development in the developing region is scraped off by the mechanical rubbing from the developing roller in an abutment portion with respect to the feed roller. At the same time, toner is fed from the feed roller to the developing roller. On the other hand, the scraped toner is mixed with the toner in the feed roller or the surrounding toner.

In a conventionally proposed developing apparatus, the surfaces of a developing roller and a feed roller are arranged to have a relative circumferential speed ratio so that a toner feed amount and undeveloped toner scraping performance are both satisfied.

For example, there has been proposed a developing apparatus in which the respective surfaces of a developing roller and a feed roller move in a forward direction (same direction) in an abutment portion therebetween, and a ratio between a circumferential speed VDR of the developing roller and a circumferential speed VSP of the feed roller is |VSP/VDR|≦0.5 or 1.5≦|VSP/VDR|≦4. In the developing apparatus, remaining of undeveloped toner on the developing roller is suppressed by setting a surface circumferential speed ratio to the above-mentioned range so as to reduce degradation of toner (see Japanese Patent Application Laid-Open No. 2006-208619).

However, as disclosed in Japanese Patent Application Laid-Open No. 2006-208619, in the developing apparatus in which the developing roller and the feed roller are arranged so that the respective surfaces move in the forward direction in the abutment portion therebetween, solid image follow-up failure in which the density of a trailing edge of an image becomes lower may occur. The solid image follow-up failure occurs in the case where a toner feed amount from the feed roller to the developing roller is insufficient, that is, in the case where a relative circumferential speed ratio which is a ratio between the circumferential speed of the developing roller and the circumferential speed of the feed roller is small. In order to satisfy sufficient solid image follow-up performance in the developing apparatus of Japanese Patent Application Laid-Open No. 2006-208619, it is necessary to select a setting at which a relative circumferential speed ratio between the developing roller and the feed roller is as high as possible, thereby increasing a toner feed amount.

Although the foregoing measure can solve the problem of solid image follow-up failure, there arises the following problem particularly in an image forming apparatus having high productivity and a high image forming speed. Specifically, a feed roller rotates at a very high speed, and a drive system relating to the feed roller generates heat. Further, the mechanical rubbing force between the feed roller and the developing roller increases to accelerate the degradation of toner. When the degradation of toner, that is, the isolation and embedding of an external additive on a toner surface is accelerated, a degree of compaction increases and toner chargeability decreases, and a problem such as toner filming in which a toner is fused onto the developing roller occurs, which prevents extension of life.

### SUMMARY OF THE INVENTION

The present invention provides a developing apparatus which is capable of preventing solid image follow-up failure and extending life with high image quality even when a relative circumferential speed ratio between a developing roller and a feed roller is set to be small so as to reduce degradation of toner.

According to an embodiment of the present invention, there is provided a developing apparatus, including: a developer carrying member configured to carry and convey developer; a developer feeding member configured to feed the developer to the developer carrying member in abutment with the developer carrying member; and a developer regulating member having a distal end portion directed toward an upstream side in a rotation direction of the developer carrying member, and configured to regulate a layer thickness of the developer carried on the developer carrying member in abutment with a surface of the developer carrying member, wherein the developer carrying member and the developer feeding member rotate so that a surface of the developer carrying member and a surface of the developer feeding member move in a same direction in an abutment portion between the developer carrying member and the developer feeding member, wherein the distal end portion of the developer regulating member has a developer taking-in portion formed into a shape away from the surface of the developer carrying member toward the upstream side in the rotation direction of the developer carrying member, and wherein the developer taking-in portion is positioned on the upstream side in the rotation direction of the developer carrying member relative to an abutment position between the developer regulating member and the developer carrying member.

Further features of the present invention will become apparent from the following description of exemplary embodiments with reference to the attached drawings.

### BRIEF DESCRIPTION OF THE DRAWINGS

FIG. 1 is a schematic view of an image forming apparatus including a developing apparatus.

FIG. 2 is a schematic view of the developing apparatus.

FIG. 3A a schematic view illustrating an abutment state of a regulating blade with respect to a developing roller according to Embodiment 1.

FIG. 3B is a schematic view illustrating an abutment state of a regulating blade with respect to a developing roller according to a comparative example.

FIG. 4A is a graph showing a result obtained by measuring a charge amount of toner with respect to VSP/VDR according to Embodiment 1.

FIG. 4B is a graph showing a result obtained by measuring an amount of pre-coat with respect to VSP/VDR according to Embodiment 1.

FIG. 5A is a schematic view illustrating a feed process in the case where the developing roller and a feed roller rotate in counter directions.

FIG. 5B is a schematic view illustrating a feed process in the case where the developing roller and the feed roller rotate along with each other.

FIG. 6 is a graph showing a comparison of an amount of coat after passing through the regulating blade with respect to VSP/VDR between Embodiment 1 and the comparative example.

FIG. 7A is a schematic view illustrating a variation in a toner taking-in region with respect to the developing roller in Embodiment 1.

FIG. 7B is a schematic view illustrating a variation in a toner taking-in region with respect to the developing roller in the comparative example.

FIG. 8 is a schematic view of a regulating blade according to Embodiments 2 and 3.

FIG. 9 is a graph showing a comparison of an amount of coat after passing through a regulating blade with respect to VSP/VDR between Embodiment 3 and comparative examples.

FIG. 10A is a schematic view of a regulating blade according to Embodiment 4.

FIG. 10B is a schematic view of a regulating blade according to Embodiment 4.

### DESCRIPTION OF THE EMBODIMENTS

Embodiments of the present invention will hereinafter be described in detail in an illustrative manner with reference to the drawings. Note that, sizes, materials, and shapes of components, and relative arrangement thereof described in the following embodiments are to be appropriately changed depending on a configuration and various conditions of an apparatus to which the present invention is applied, and the scope of the present invention is not intended to be limited to the following embodiments.

### Embodiment 1

In an embodiment of the present invention described below, a developing apparatus to be used in an image forming apparatus will be described in an illustrative manner.

(1) Overview of Configuration and Operation of Image Forming Apparatus

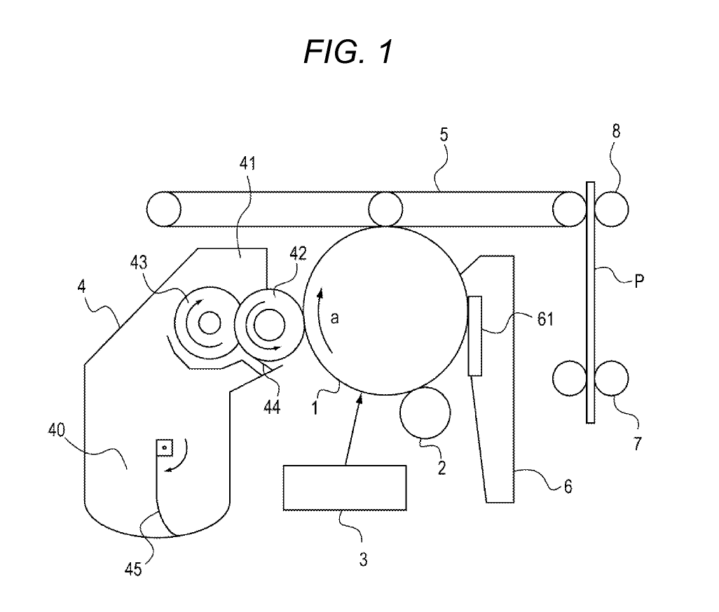

FIG. 1 is a structural view illustrating an entire schematic configuration of an image forming apparatus according to Embodiment 1. The image forming apparatus includes a charging roller 2, an exposure device 3, a developing apparatus 4, a transfer belt 5, and a cleaning device 6 arranged in this order around a drum-shaped photosensitive drum 1 which is an image bearing member. The charging roller 2 is a charging unit configured to uniformly charge the surface of the photosensitive drum 1. The exposure device 3 is an exposure unit configured to irradiate the photosensitive drum 1 with laser light modulated according to image information. The developing apparatus 4 is a developing unit configured to develop an electrostatic latent image formed on the photosensitive drum 1 to form a toner image. The transfer belt 5 is an intermediate transfer member configured to transfer the toner image formed on the photosensitive drum 1. The cleaning device 6 is a cleaning unit configured to remove toner remaining on the photosensitive drum 1 after the toner image is transferred.

Further, the image forming apparatus includes a registration roller pair 7 configured to feed and convey a transfer sheet P serving as a recording medium in synchronism with the rotation of the photosensitive drum 1 from a sheet feed tray (not shown), and a secondary transfer roller 8 provided at an end of the intermediate transfer belt 5, configured to transfer the toner image onto the transfer sheet P. Further, although not shown, the image forming apparatus includes a fixing device configured to fix the toner image on the transfer sheet P.

In the image forming apparatus with the configuration as described above, the surface of the photosensitive drum 1 which rotates in a direction indicated by an arrow “a” is uniformly charged to a positive or negative predetermined charge potential by the charging roller 2 and thereafter is scanned and irradiated in a photosensitive drum axial direction with laser light modulated according to image information. As a result, an electrostatic latent image is formed on the photosensitive drum 1. The electrostatic latent image formed on the photosensitive drum 1 is developed into a toner image by adhering thereto charged toner (developer) by the developing apparatus 4 in a developing region. After that, the toner image on the photosensitive drum 1 is temporarily transferred onto the transfer belt 5 by supplying the transfer belt 5 with charge having a polarity opposite to that of the toner image.

On the other hand, the transfer sheet P is fed and conveyed by a feeding and conveying device (not shown) and sent and conveyed to a secondary transfer portion, in which the transfer belt 5 and the secondary transfer roller 8 are opposed to each other, at a predetermined timing by the registration roller pair 7. Then, the toner image on the transfer belt 5 is transferred onto the transfer sheet P by supplying the secondary transfer roller 8 with charge having a polarity opposite to that of the toner image. Then, the transfer sheet P is separated from the transfer belt 5, sent to the fixing device (not shown), and delivered out of the apparatus after the toner image is fixed by the fixing device.

The surface of the photosensitive drum 1 after the toner image has been transferred onto the transfer belt 5 is cleaned by a cleaning blade 61 of the cleaning device 6 to remove the toner remaining on the photosensitive drum 1.

(2) Overview of Configuration and Operation of Developing Apparatus

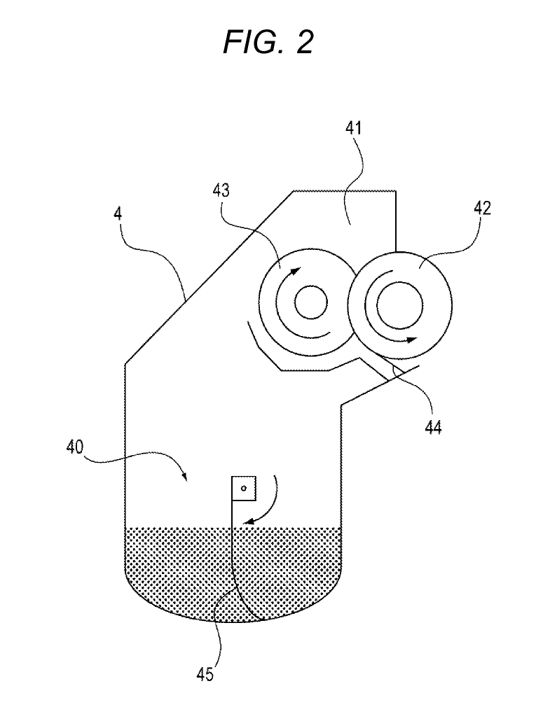

Next, the developing apparatus 4 will be described. FIG. 2 is a structural view illustrating a configuration of the developing apparatus 4. As illustrated in FIG. 2, the developing apparatus 4 includes a developing roller 42 serving as a developer carrying member of which a circumferential surface is partially exposed from an opening of the developing apparatus 4 and opposed to the photosensitive drum 1, a feed roller 43 serving as a developer feeding member, and a regulating blade 44 serving as a developer regulating member. Further, the developing apparatus 4 includes an agitator 45 serving as a developer conveying member in a toner containing chamber 40.

The developing roller 42 carries and conveys toner serving as developer. The feed roller 43 abuts on the developing roller 42 to feed the toner to the developing roller 42. The regulating blade 44 abuts on the developing roller 42 with a distal end portion thereof which is a free end directed to an upstream side in a rotation direction of the developing roller 42, to thereby regulate the thickness of a toner layer carried on the developing roller 42. In the developing apparatus 4, the developing roller 42 and the feed roller 43 are configured to rotate in such a manner that the respective surfaces thereof move in the same direction in an abutment portion therebetween.

The overview of an operation of the developing apparatus 4 will hereinafter be described.

In the developing apparatus 4, toner contained in the toner containing chamber 40 is drawn up by the agitator to a developing chamber 41 in which the developing roller 42 is provided. The toner thus drawn up is stored on an upper side in a gravity direction of a contact portion between the developing roller 42 and the feed roller 43 and is mechanically rubbed in the contact portion between the feed roller 43 and the developing roller 42 along with the rotation of the feed roller 43. Due to the rubbing, the toner becomes charged triboelectrically to be carried and fed onto the developing roller 42.

The toner fed to the developing roller 42 is reduced in a layer thickness appropriately by the regulating blade 44 which is in abutment with the developing roller 42 through intermediation of the toner. Simultaneously, the toner fed to the developing roller 42 is sandwiched between the developing roller 42 and the regulating blade 44 to be rubbed by the surface of the developing roller 42 and the surface of the regulating blade 44, and thus become charged triboelectrically to a desired polarity. Then, the toner is conveyed to the developing region, which is a portion opposed to the photosensitive drum 1, due to the rotation of the developing roller 42 in the arrow direction. In the developing region, the toner layer on the developing roller develops an electrostatic latent image on the photosensitive drum 1 with a developing electric field generated by a bias application unit (not shown), and visualizes the electrostatic latent image as a toner image. The toner layer remaining on the developing roller 42 without being used for development in the developing region is rubbed and mixed in the abutment portion with respect to the feed roller 43. Simultaneously, developer is newly fed onto the developing roller 42 due to the rotation of the feed roller 43. On the other hand, undeveloped toner which has been rubbed and mixed by the feed roller 43 is returned to the toner containing chamber 40 positioned below due to the rotation of the feed roller 43, and is agitated and mixed in the toner containing chamber 40 by the rotation of the agitator 45.

A detailed condition of each portion of the developing apparatus 4 in Embodiment 1 will hereinafter be described.

As the toner, negatively chargeable toner of a non-magnetic, one-component type is used. Note that, in Embodiment 1, toner having a degree of compaction of 5% to 40% in an initial state is used. Using toner having such a degree of compaction enables flowability of toner to be ensured through endurance. Further, the degree of compaction of toner was measured as follows.

As a measurement apparatus, a powder tester (manufactured by Hosokawa Micron Corporation) having a digital vibration meter (Model 1332 manufactured by Showa Sokki Corporation) was used.

As a measurement method, 390-mesh, 200-mesh, and 100-mesh sieves were set on a vibration table in order of increasing an opening size. That is, the sieves were stacked in the order of the 390-mesh, 200-mesh, and 100-mesh sieves so that the 100-mesh sieve was placed in an uppermost position.

A sample (toner) of 5 g weighed correctly was added to the thus set 100-mesh sieve, and a displacement value of the digital vibration meter was adjusted to 0.60 mm (peak-to-peak). Under this condition, vibration was applied to the sample for 15 seconds. After that, a mass of the sample remaining in each sieve was measured, and a degree of compaction was obtained based on the following expression. The measurement sample at this time had been left to stand in an environment of a temperature of 23° C. and a humidity of 60% RH for 24 hours, and the measurement was performed in an environment of a temperature of 23° C. and a humidity of 60% RH.

Degree of compaction (%)=(Mass of remaining sample on 100-mesh sieve/5 g)×100+(Mass of remaining sample on 200-mesh sieve/5 g)×60+(Mass of remaining sample on 390-mesh sieve/5 g)x20

As the feed roller 43, a roller having a diameter of 15 mm is used in which flexible foamed polyurethane is formed on an electro-conductive cored bar having a diameter of 6 mm. Further, as a surface hardness of the feed roller 43, 50° to 80° measured in the Asker-F hardness can be used. Further, the feed roller 43 is provided in an inroad amount of 1.0 mm with respect to the developing roller 42.

As the developing roller 42, a roller having a diameter of 15 mm is used in which silicone rubber as a base layer and urethane rubber as a surface layer formed thereon are formed on an electro-conductive cored bar having a diameter of 6 mm. As a volume resistivity of the developing roller 42, 1×10⁴ Ω·cm to 1×10¹² Ω·cm can be used. Further, as a surface hardness of the developing roller 42, a range of 30° to 75° measured in the Asker-C hardness can be used. Further, a rotation speed of the developing roller 42 is 200 rpm.

The feed roller 43 rotates in a direction opposite to that of the developing roller 42. That is, the feed roller 43 rotates so that the respective surfaces of the developing roller 42 and the feed roller 43 move in the same direction in the abutment portion therebetween. A ratio of a surface circumferential speed VSP of the feed roller 43 to a surface circumferential speed VDR of the developing roller 42, that is, VSP/VDR is set to 140% so as to suppress the degradation of toner.

(3) Configuration and Effect of Regulating Blade

Next, the configuration of the regulating blade 44 will be described.

The regulating blade 44 serving as the developer regulating member abuts in a so-called “counter” direction on the developing roller 42. That is, the regulating blade abuts on the developing roller 42 with a distal end portion thereof which is a free end directed to an upstream side in a rotation direction of the developing roller 42, as illustrated in FIG. 2. Further, the regulating blade 44 is provided so that the distal end portion thereof is directed upward with respect to the developing roller 42. The regulating blade 44 is made of a SUS plate having a thickness of 1 mm and the distal end portion thereof abuts on the developing roller 42 at 20 gf/cm. Further, the regulating blade 44 and the cored bar of the developing roller 42 are set to the same potential.

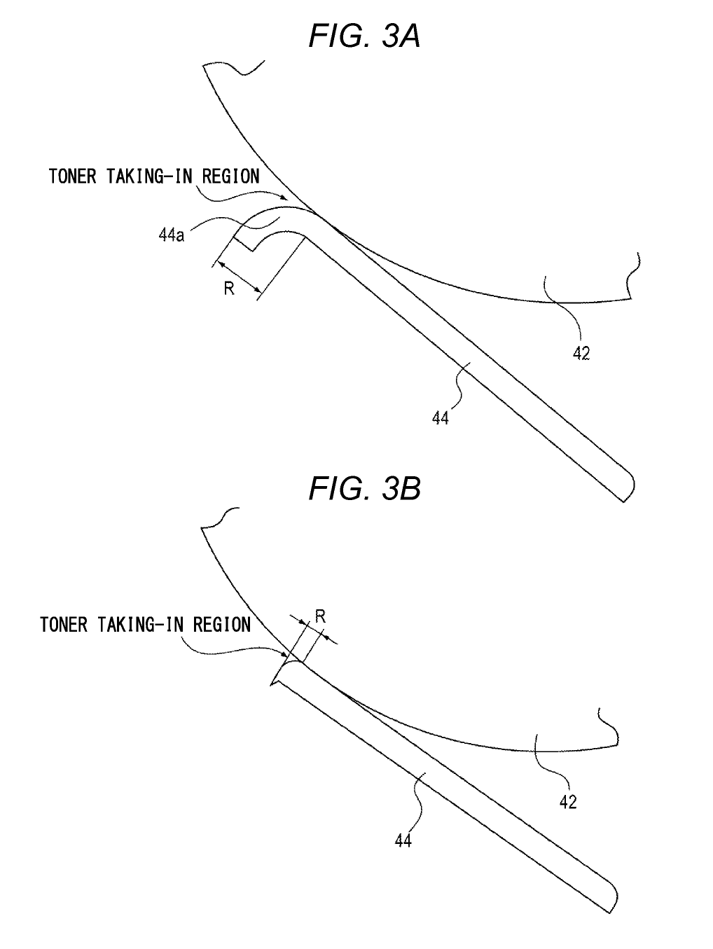

FIG. 3A is an enlarged view of the shape of the distal end portion of the regulating blade 44. The distal end portion of the regulating blade 44 is provided with a developer taking-in portion (toner taking-in region) formed into a shape so as to be getting away from the surface of the developing roller 42 toward the upstream side in the rotation direction of the developing roller 42. In this case, as the developer taking-in portion, an arc portion 44a formed into a shape so as to be getting away from the surface of the developing roller 42 toward the upstream side in the rotation direction of the developing roller 42 is provided at the distal end portion. The regulating blade 44 is arranged so that the distal end portion provided with the arc portion 44a abuts on the developing roller 42 in such a manner that the arc portion 44a is positioned on the upstream side in the rotation direction of the developing roller 42 relative to an abutment position with respect to the developing roller 42.

The arc portion 44a in the distal end portion of the regulating blade 44 has a predetermined curvature radius R. The curvature radius R of the arc portion 44a of the distal end portion of the regulating blade 44 can be set in a range of 0.1 mm to 0.5 mm. As a method of forming the arc portion 44a having the curvature radius R in the distal end portion of a SUS plate (SUS blade) as in Embodiment 1, electrochemical mechanical processing, discharge mechanical processing, or laser beam mechanical processing can be used besides bending processing such as pressing. The distal end portion of the regulating blade 44 provided with the arc portion 44a is arranged so as to abut on the developing roller 42.

Functional effects of Embodiment 1 will hereinafter be described by way of a comparative example.

(3-1) Effects on Solid Image Follow-Up Failure

As illustrated in FIG. 3B, in Comparative Example 1-1, the distal end portion of the regulating blade (SUS plate) 44 was cut from the side of the abutment surface of the developing roller 42. As illustrated in FIG. 3B, the distal end portion of the regulating blade 44 was curved in a cut direction due to the cutting, and a curved amount of the distal end corresponding to the curvature radius R was 0.02 mm. Embodiments 1-1, 1-2, and 1-3 are directed to the cases where the curvature radius R of the distal end portion (arc portion) of the regulating blade 44 was 0.1 mm, 0.3 mm, and 0.5 mm, respectively.

Table 1 shows results obtained by verifying the presence/absence of solid image follow-up failure with respect to VSP/VDR with the rotation speed of the feed roller 43 being arbitrarily variable in the image forming apparatus. The case where the VSP/VDR is a negative value corresponds to the state in which the surface of the feed roller 43 rotates in a direction opposite to that of the surface of the developing roller 42 in the abutment portion (hereinafter referred to as “counter” rotation). On the other hand, the case where the VSP/VDR is a positive value corresponds to the state in which the rotation direction of the surface of the feed roller 43 is the same as that of the surface of the developing roller 42 in the abutment portion (hereinafter referred to as “with” rotation). The case where the VSP/VDR is 100% means the condition under which the surface circumferential speed of the feed roller 43 and that of the developing roller 42 are the same in the abutment portion, and the case where the VSP/VDR is 0% means the condition under which the feed roller 43 is ceased in the abutment portion.

Further, solid image follow-up performance was determined under the following conditions. A background potential on the photosensitive drum 1 was set to −500 V, a bright section potential as a potential after exposure was set to −100 V, and a developing bias applied to the cored bar of the developing roller 42 was set to −300 V in the image forming apparatus. A printing environment was a temperature of 23° C. and a humidity of 50%. A solid image was printed over a surface of a letter sheet (11×8.5 inches) in short edge feed and the obtained image was observed. The image was determined as follows: density is sufficient (∘), density is slightly insufficient (Δ), and density is insufficient (×).

In both Comparative Example 1-1 and Embodiments 1-1 to 1-3, no solid image follow-up failure occurred in a “counter” rotation of −90%. Further, no solid image follow-up failure occurred even in the “with” rotation of 290% having a relative speed difference equivalent to -90%. However, in Comparative Example 1-1, solid image follow-up failure occurred under the condition that the VSP/VDR became small, irrespective of whether the rotation was the “counter” rotation or the “with” rotation. On the other hand, in Embodiments 1-1 to 1-3, solid image follow-up failure occurred in the case where the VSP/VDR was set to be small in the “counter” rotation, but no solid image follow-up failure occurred even when a circumferential speed ratio was decreased from 290% in the “with” rotation.

As shown in Table 1, in the case where the rotation is the “with” rotation and the VSP/VDR is set to be small, which is advantageous against the degradation of toner, a unique effect of being able to prevent the occurrence of solid image follow-up failure can be exhibited through the use of the regulating blade 44 having the distal end portion provided with the arc portion of Embodiment 1.

TABLE 1

| | Curvature | VSP/VDR | | | | |
|---|---|---|---|---|---|---|
| | radius R | −90% | −50% | 140% | 180% | 290% |
| Comparative | 0.02 mm | ◯ | X | X | X | ◯ |
| Example 1-1 | | | | | | |
| Embodiment | 0.1 mm | ◯ | X | ◯ | ◯ | ◯ |
| 1-1 | | | | | | |
| Embodiment | 0.3 mm | ◯ | X | ◯ | ◯ | ◯ |
| 1-2 | | | | | | |
| Embodiment | 0.5 mm | ◯ | X | ◯ | ◯ | ◯ |
| 1-3 | | | | | | |

First, the above-mentioned unique effect is attributed to the feature in which the properties of a toner coat (hereinafter referred to as “pre-coat”) on the developing roller 42 immediately before being regulated by the regulating blade 44 vary between the “with” rotation and the “counter” rotation. Specifically, in the case of the “with” rotation, the unique effect is attributed to the feature in which a toner charge amount of pre-coat is relatively high compared to that in the case of the “counter” rotation. Second, the unique effect is attributed to the feature in which, when the distal end portion (arc portion 44a) of the regulating blade 44 abuts on the developing roller 42, even when the amount of pre-coat is small, the amount of coat after passing through the regulating blade 44 increases compared to that of Comparative Example 1-1, when the charge amount of toner is high.

In the following, the first feature, that is, the feature in which, in the case of the “with” rotation, a toner charge amount of pre-coat is relatively high compared to that in the case of the “counter” rotation will be described in detail together with experimental results.

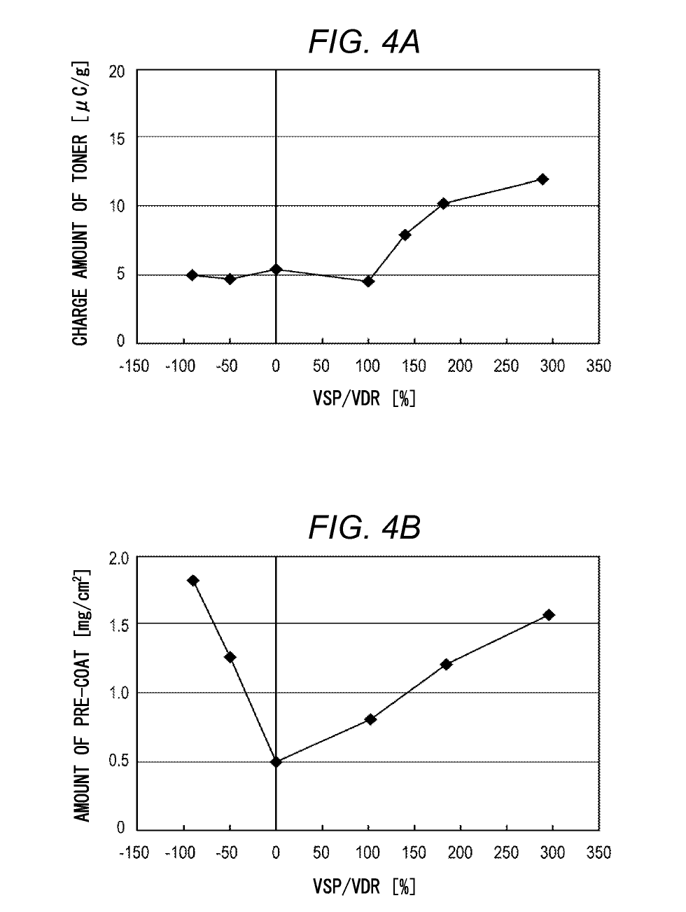

FIGS. 4A and 4B show experimental results obtained by verifying, in the developing apparatus 4 of Embodiment 1, a relationship between the amount of pre-coat (mg/cm²) and the VSP/VDR, and a relationship between the toner charge amount of pre-coat (μC/g) and the VSP/VDR. The pre-coat is measured after ceasing the operation of the developing apparatus 4 in the vicinity of a trailing edge of an image during solid image printing.

First, the tendency of the toner charge amount of pre-coat will be described. As shown in FIG. 4A, in the “counter” rotation, the toner charge amount of pre-coat tends to be substantially constantly low irrespective of the amount of pre-coat, and in the “with” rotation, the charge amount of toner tends to increase from a point at which a surface circumferential speed ratio exceeds 100%. The difference in tendency is attributed to the different pre-coat formation processes between the “counter” rotation and the “with” rotation.

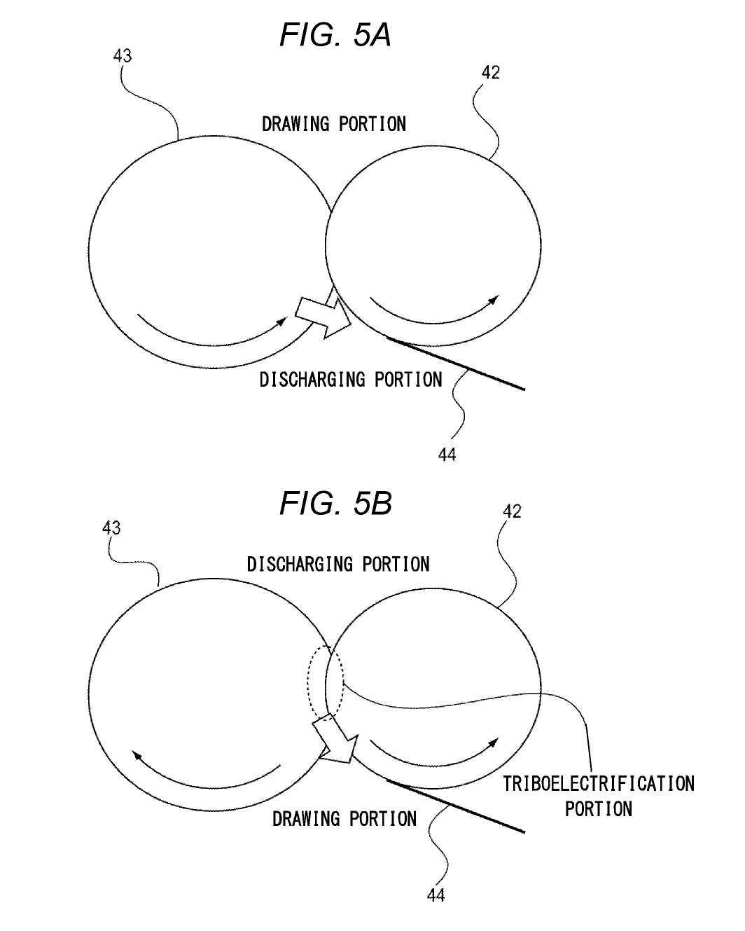

The difference in feed process between the “counter” rotation and the “with” rotation will be described with reference to the schematic views of FIGS. 5A and 5B. In the case of the “counter” rotation illustrated in FIG. 5A, after toner on the developing roller 42 is consumed, toner having a low charge amount contained in the feed roller 43 is discharged in an arrow direction in the abutment portion between the developing roller 42 and the feed roller 43 to form a pre-coat. Therefore, even when a circumferential speed ratio of the feed roller 43 is changed, a charge amount of toner is substantially constantly low in the “counter” rotation region.

On the other hand, in the “with” rotation, a toner drawing portion of the feed roller 43 corresponds to a toner feed side with respect to the developing roller 42 as illustrated in FIG. 5B. Thus, the toner having a low charge amount contained in the feed roller 43 is not directly fed to the developing roller 42. In the case of the “with” rotation, the toner contained in the feed roller 43 or the surrounding toner conveyed by the feed roller 43 is rubbed by a nip (abutment portion) between the developing roller 42 and the feed roller 43 to become charged triboelectrically, and adheres to the developing roller 42 with an image force to form a pre-coat.

Due to the difference in feed process, the toner charge amount of pre-coat on the developing roller becomes higher in the “with” rotation compared to that in the “counter” rotation. The triboelectrification becomes more active as the VSP/VDR increases, and hence, when the VSP/VDR increases as shown in FIG. 4A, the toner charge amount of pre-coat tends to increase.

As shown in FIG. 4B, the amount of pre-coat depends on the VSP/VDR. The gradient of the amount of pre-coat with respect to the VSP/VDR is larger in the “counter” rotation, and in the “with” rotation, the gradient of the amount of pre-coat with respect to the VSP/VDR is smaller compared to that of the “counter” rotation. This tendency is attributed to the difference in relative circumferential speed between the feed roller 43 and the developing roller 42 with respect to the VSP/VDR of the horizontal axis and to the difference in feed process between the “with” rotation and the “counter” rotation as described above.

Next, the second feature, that is, the feature in which, when the distal end portion (arc portion 44a) of the regulating blade 44 abuts on the developing roller 42, even when the amount of pre-coat is small, the amount of coat after passing through the regulating blade 44 increases compared to that of Comparative Example 1-1, when the charge amount of toner is high, will be described in detail together with experimental results.

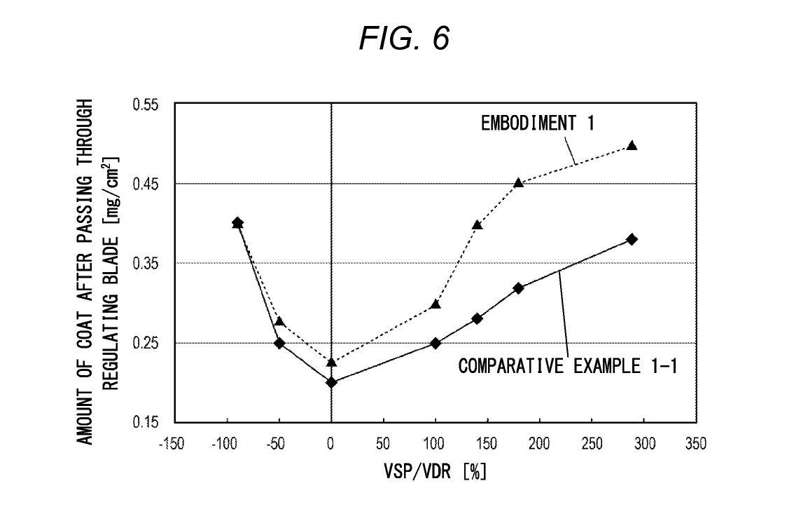

FIG. 6 shows results obtained by verifying a relationship between the amount of coat and the VSP/VDR in each of Embodiment 1-1 and Comparative Example 1-1. The amount of coat on the developing roller 42 after passing through the regulating blade 44 was measured after ceasing the operation of the developing apparatus 4 at a trailing edge of a solid image in the same way as in the case of the amount of pre-coat.

As shown in FIG. 6, the amount of coat with respect to a pre-coat having a low toner charge amount in the case of a negative region of the VSP/VDR, that is, the “counter” rotation, is substantially the same between Embodiment 1-1 in which the curvature radius R of the distal end portion of the regulating blade 44 is 0.1 mm and Comparative Example 1-1 in which the curvature radius R of the distal end portion of the regulating blade 44 is 0.02 mm. In contrast, the amount of coat with respect to a pre-coat having a high toner charge amount in the case of a positive region of the VSP/VDR, that is, the “with” rotation, is larger in the case of Embodiment 1-1 compared to that in the case of Comparative Example 1-1.

The results are attributed to the following fact. That is, in Embodiment 1-1, as illustrated in FIG. 3A, the arc portion 44a is provided as the developer taking-in portion in the distal end portion of the regulating blade 44 to enlarge the toner taking-in region, thereby forming a region for holding toner.

In such a case, when the toner charge amount of pre-coat is relatively high, toner having a charge amount is to be held by the distal end of the regulating blade 44, with the result that there is obtained an effect that the amount of pre-coat increases seemingly. On the other hand, in the case of the low toner charge amount of pre-coat, that is, the “counter” rotation, toner is less likely to be held by the distal end of the regulating blade 44 because an image force with respect to the developing roller 44 is weak. Further, even when the toner was held by the distal end of the regulating blade 44, the effect of increasing the amount of pre-coat seemingly was not obtained because the attractive force of the toner with respect to the developing roller 44 was low.

On the other hand, in Comparative Example 1-1, as illustrated in FIG. 3B, the toner taking-in region in the distal end portion of the regulating blade 44 is narrow, and hence, the effect of Embodiment 1-1 cannot be obtained. In the regulating process, when a pre-coat is reduced in amount to become sparse, an upper layer of the pre-coat is scraped off and toner is passed through only a lower layer thereof. Therefore, a coat is formed on the developing roller 42 while the pre-coat is sparse. When a solid image continues to be printed in such a state, the amount of coat on the developing roller 42 becomes insufficient when the feed amount from the feed roller decreases at a trailing edge of an image, thereby causing solid image follow-up failure. The foregoing are the functional effects of the invention with respect to solid image follow-up failure.

(3-2) Verification of Level of Fog in Low-Temperature and Low-Humidity Environment

Next, the results obtained by verifying the level of fog in which toner adheres to an image background portion are described. Blank page printing was performed under the image formation condition equivalent to that of Table 1 in an experimental environment of a temperature of 15° C. and a humidity of 10% as a low-temperature and low-humidity environment, and the level of fog was determined as follows: no fog is present (◯), fog is present slightly (Δ), and fog is present in a large amount (Δ). Note that, no fog occurred in the experimental environment of a temperature of 23° C. and a humidity of 50% shown in Table 1.

TABLE 2

| | Curvature | VSP/VDR | | | | |
|---|---|---|---|---|---|---|
| | radius R | −90% | −50% | 140% | 180% | 290% |
| Comparative | 0.02 mm | ◯ | ◯ | ◯ | ◯ | ◯ |
| Example 1-1 | | | | | | |
| Embodiment | 0.1 mm | ◯ | ◯ | ◯ | ◯ | ◯ |
| 1-1 | | | | | | |
| Embodiment | 0.3 mm | ◯ | ◯ | ◯ | ◯ | ◯ |
| 1-2 | | | | | | |
| Embodiment | 0.5 mm | ◯ | ◯ | ◯ | ◯ | X |
| 1-3 | | | | | | |

As shown in Table 2, a fog level (×) was observed in the “with” rotation in which the curvature radius R of the distal end portion (arc portion 44a) of the regulating blade 44 was 0.5 mm and the VSP/VDR was 290%. On the other hand, no fog occurred in the “counter” rotation. In the following, the reason for this tendency will be described.

Fog occurred when the amount of coat of the developing roller 42 prior to development became too large. The feed roller 43 forms a pre-coat on the developing roller 42, and thereafter, the charge amount of the toner regulated by the regulating blade 44 and charged triboelectrically becomes higher than that of the pre-coat. Then, the undeveloped toner without being used for forming an image reaches the abutment portion (nip) between the feed roller 43 and the developing roller 42 again and is scrapped off, and the charge amount of the undeveloped toner becomes uniform with that of the surrounding toner. However, this function is not perfect, and the toner charge amount of pre-coat becomes higher prior to development, that is, after blank page printing, compared to that after solid black image printing. When the regulating blade 44 including the distal end portion (arc portion 44a) having a large curvature radius R is used for the pre-coat prior to development, the amount of coat tends to increase.

Then, the charge amount of toner becomes higher in an environment of a temperature of 15° C. and a humidity of 10% than in an environment of a temperature of 23° C. and a humidity of 50%. Therefore, under the condition of the VSP/VDR of 290% in which the toner charge amount of pre-coat became high even when the curvature radius R was 0.5 mm, the fog level (×) was observed.

A preferred range of the curvature radius R of the distal end portion (arc portion 44a) of the regulating blade 44, in which both the prevention of solid image follow-up failure and the prevention of fog in a low-temperature and low-humidity environment were satisfied when the VSP/VDR was set to 140% so as to suppress the degradation of toner by the developing apparatus 4 according to Embodiment 1, was a range of 0.1 mm to 0.5 mm as shown in Tables 1 and 2.

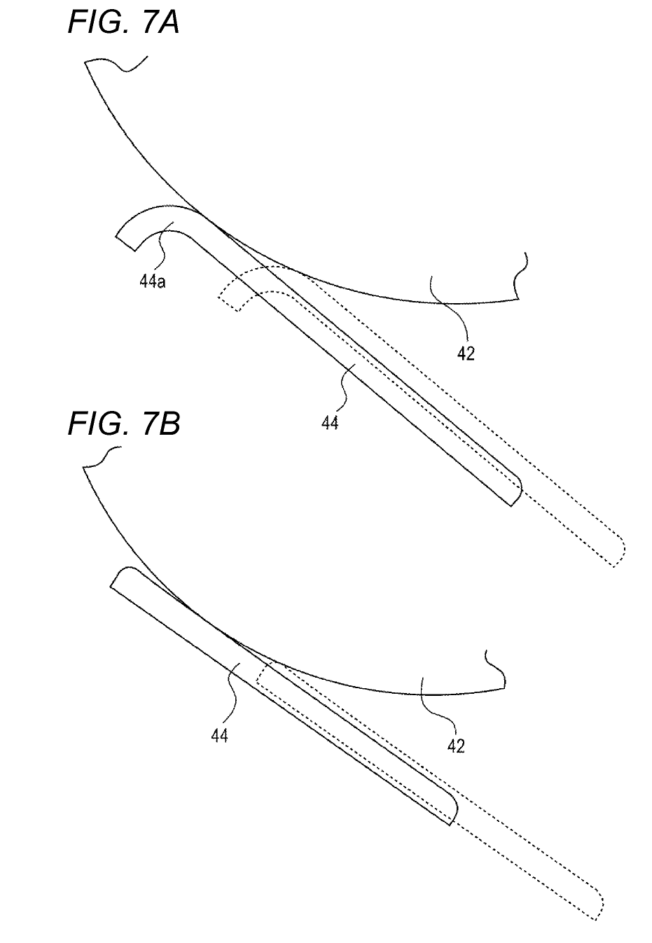

Note that, even when body abutment in which a distal end portion of a regulating blade protrudes from the developing roller is performed by using the regulating blade including the distal end portion having a smaller curvature as in Comparative Example 1-1 in comparison with the curvature radius R of the distal end portion of the regulating blade 44 of Embodiment 1, the effect of Embodiment 1 cannot be obtained. As indicated by a solid line in FIG. 7B, although a toner taking-in region can be formed by performing body abutment in which the distal end portion of the regulating blade 44 protrudes from the developing roller 42 in Comparative Example 1-1, fog occurs. The reason for this is as follows: when the body abutment indicated by the solid line in FIG. 7B is performed, an abutment nip width between the regulating blade 44 and the developing roller 42 is enlarged and a regulating force becomes remarkably weaker compared to the case where the distal end portion of the regulating blade 44 abuts on the developing roller 42 as indicated by a broken line in FIG. 7B. On the other hand, in the embodiment illustrated in FIG. 7A, when a portion (arc portion 44a) having a curvature in the distal end portion of the regulating blade abuts on the developing roller 42, a toner taking-in region in a preferred range capable of holding a pre-coat while keeping the nip width narrow can be obtained.

Further, as an arrangement configuration to be employed when the regulating blade 44 including a portion (arc portion 44a) having a curvature in the distal end portion as in Embodiment 1 abuts on the developing roller 42, the regulating blade 44 is arranged to abut on the developing roller 42 so that the distal end portion is directed upward. Thus, the problem of solid image follow-up failure tends to be further suppressed. The reason for this is as follows: the pre-coat held in the toner taking-in region does not fall downward due to the gravity compared to the case where the distal end portion of the regulating blade 44 is arranged so as to be directed downward. By arranging the regulating blade 44 in such a manner that the regulating blade 44 abuts on the developing roller 42 so that the distal end portion thereof is directed upward, a pre-coat having a high toner charge amount is liable to be held in the toner taking-in region, and hence, the effect of Embodiment 1 is further enhanced.

Accordingly, due to the configuration of Embodiment 1, even in the case where the VSP/VDR is decreased so as to suppress the degradation of toner, a pre-coat having a high toner charge amount unique to the “with” rotation can be taken in the abutment nip portion between the developing roller 42 and the regulating blade 44. Thus, a developing apparatus can be realized, in which the solid image follow-up failure and occurrence of fog are prevented, and the life is extended with high image quality.

### Embodiment 2

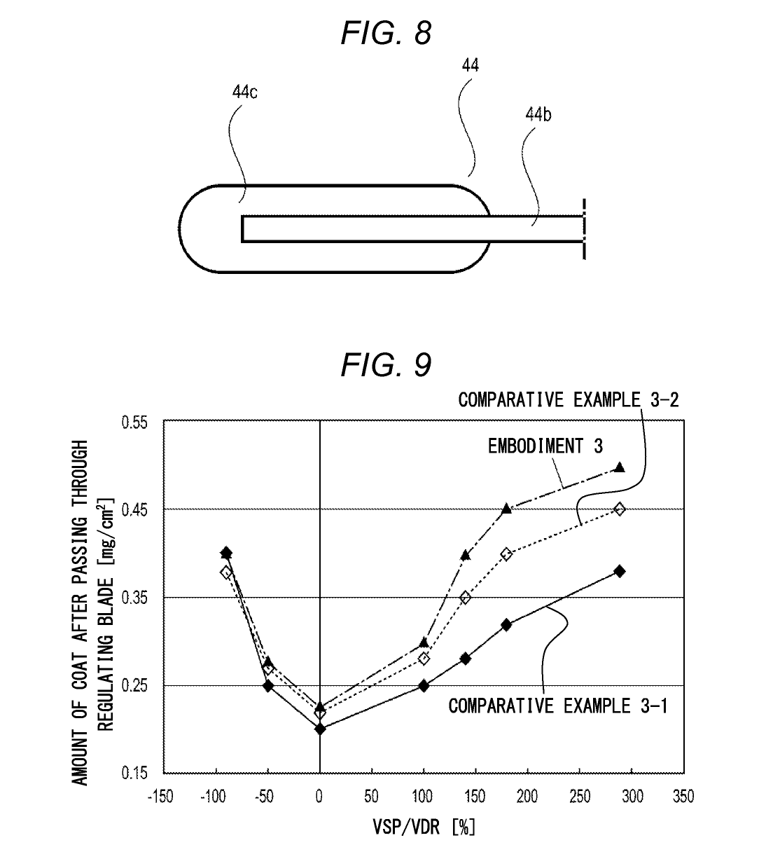

As illustrated in FIG. 8, the regulating blade 44 of Embodiment 2 of the present invention has a configuration in which a distal end portion that abuts on the developing roller 42 is formed by applying an insulating elastomer 44c to an end portion of a support 44b. The configuration and effect of the regulating blade 44 using the insulating elastomer of Embodiment 2 will be described by way of comparative examples. The regulating blade 44 used in Embodiment 2 is a regulating blade disclosed in Japanese Patent Application Laid-Open No. 2008-090160 in which the support 44b of a metallic SUS plate having a thickness of 0.1 mm is coated with the polyamide elastomer 44c as an insulating elastomer.

Table 3 shows results obtained by determining a fog level with respect to VSP/VDR in Embodiment 2. An experiment was performed in an environment of a temperature of 15° C. and a humidity of 10%. Regulating blades (SUS blades) provided with distal end portions having curvature radii R of 0.5 mm and 0.7 mm, respectively, by press working are defined as Comparative Examples 2-1 and 2-2. Further, regulating blades using an insulating polyamide elastomer are defined as Embodiments 2-1 and 2-2, and Comparative Example 2-3. Table 3 shows a curvature radius R of each regulating blade. Further, the potential of the regulating blade 44 is set to be the same as that of the cored bar of the developing roller 42.

TABLE 3

| | Curvature | VSP/VDR | | | | |
|---|---|---|---|---|---|---|
| | radius R | −90% | −50% | 140% | 180% | 290% |
| Comparative | 0.5 mm | ◯ | ◯ | ◯ | ◯ | X |
| Example 2-1 | | | | | | |
| Comparative | 0.7 mm | ◯ | ◯ | X | X | X |
| Example 2-2 | | | | | | |
| Embodiment | 0.5 mm | ◯ | ◯ | ◯ | ◯ | ◯ |
| 2-1 | | | | | | |
| Embodiment | 0.7 mm | ◯ | ◯ | ◯ | ◯ | X |
| 2-2 | | | | | | |
| Comparative | 0.9 mm | ◯ | ◯ | X | X | X |
| Example 2-3 | | | | | | |

As shown in Comparative Example 2-2 and Embodiment 2-2 of Table 3, even when the curvature radius R was 0.7 mm, fog at VSP/VDR of 140% was suppressed at a satisfactory level in the case of the regulating blade using an insulating polyamide elastomer, compared to the metallic regulating blade. That is, compared to Embodiment 1, the range of the curvature radius R in the arc portion in the distal end portion of the regulating blade 44 was enlarged in Embodiment 2. The effects on solid image follow-up failure were the same as those shown in Table 2 both in Comparative Examples 2-1 and 2-2 and in Embodiments 2-1 and 2-2.

The effects on fog are attributed to the following: a work function of the abutment surface of the distal end portion that abuts on the developing roller 42 is larger in the case of the regulating blade using an insulating polyamide elastomer, that is, the ability of the regulating blade 44 to impart a charge amount to toner is lower, compared to the metallic regulating blade. Fog occurs when the amount of coat prior to development becomes too large. As described above, prior to development, that is, during blank page printing, the toner charge amount of pre-coat becomes higher. When a regulating blade including a distal end portion having a large curvature radius is used with respect to such a pre-coat, fog is liable to occur.

However, when an elastomer which is a material having low charge amount imparting ability compared to a metal is used as the regulating blade as in Embodiments 2-1 and 2-2, the charge amount of toner after passing through the regulating blade becomes stably lower. Thus, the charge amount of toner of pre-coat prior to development also becomes stably lower than those of Comparative Examples 2-1 and 2-2. Therefore, even in the regulating blade in which the distal end portion that abuts on the developing roller is formed of an elastomer and an arc portion is provided in the distal end portion as in Embodiment 2, the amount of coat does not increase excessively, and fog is suppressed at a satisfactory level.

However, as shown in Comparative Example 2-3 of Table 3, even when an elastomer which is a material having lower charge amount imparting ability than a metal is used as the regulating blade, in the case where the regulating blade having a curvature radius R of 0.9 mm is used, fog occurs at VSP/VDR of 140%. In the developing apparatus 4 according to Embodiment 2, a preferred range of the curvature radius R of the distal end portion (arc portion) of the regulating blade using an insulating elastomer was 0.1 mm to 0.7 mm.

Further, although a polyamide elastomer was used as a material (resin for setting the work function of the abutment surface of the distal end portion of the regulating blade that abuts on the developing roller to be higher than that of a metal) of the regulating blade in Embodiment 2, the present invention is not limited thereto. For example, polyamide, polyester, a polyester elastomer, polyester terephthalate, polyurethane, silicone rubber, a silicone resin, or a melamine resin can be used.

Further, in Embodiment 2, although the example using the regulating blade in which a metallic support is coated with a polyamide elastomer is described, the present invention is not limited thereto. The effects of the present invention can be obtained, for example, as long as the material on the side of the regulating blade in the abutment portion between the regulating blade and the developing roller is the above-mentioned material, and the regulating blade has a shape in the above-mentioned range of the curvature radius R in the distal end portion.

Due to the configuration of Embodiment 2, even in the case where the VSP/VDR is decreased so as to suppress the degradation of toner, a pre-coat having a high toner charge amount unique to the “with” rotation can be taken in the abutment nip portion between the developing roller 42 and the regulating blade 44. Thus, a developing apparatus can be realized, in which the solid image follow-up failure and occurrence of fog are prevented, and the life is extended with high image quality.

### Embodiment 3

In Embodiment 3 of the present invention, a configuration will be described in an illustrative manner, in which a bias is applied to a regulating blade through use of an elastomer that is provided with conductivity by the addition of an electro-conductive agent. The shape of the regulating blade of the embodiment was the same as that illustrated in FIG. 8 and had a volume resistivity of 1×10⁶ Ω·cm to 1×10⁹ Ω·cm obtained by adding an ionic electro-conductive agent to a polyamide elastomer as an electro-conductive resin. As a blade bias, a voltage of −400 V was applied to the support (SUS plate) 44b of the regulating blade 44 illustrated in FIG. 8 with respect to a developing bias of −300 V to be applied to the cored bar of the developing roller, to thereby provide a potential difference of −100 V.

FIG. 9 shows results obtained by verifying a relationship of the amount of coat after passing through the regulating blade with respect to the VSP/VDR so as to show the effects of the embodiment. An experiment in FIG. 9 was performed under the same condition as that for measuring the amount of pre-coat with respect to the VSP/VDR shown in FIG. 4B. Comparative Example 3-1 is directed to the case where the curvature radius R of the distal end portion (arc portion) of the regulating blade is 0.02 mm and a blade bias is 0 V, and Comparative Example 3-2 is directed to the case where the configuration of the distal end portion of the regulating blade has the same configuration as that of the embodiment and a blade bias is 0 V.

In Embodiment 3, the following effects were obtained: the amount of coat increased in the “with” rotation region of the VSP/VDR compared to Comparative Example 3-1, the solid image follow-up performance at VSP/VDR of 140% was further improved compared to Comparative Example 3-2, and the VSP/VDR was reduced to less than 140%.

The effects are attributed to pre-coat properties unique to the “with” rotation configuration in which the toner charge amount of pre-coat after solid black image printing becomes higher. In the “with” rotation, the toner charge amount of pre-coat is high, and hence, the pre-coat is liable to be influenced by an electric field generated by the application of a bias to the regulating blade. Due to the application of a bias to the regulating blade, the amount of toner pressed against the developing roller from the regulating blade increases, and hence, the effect of increasing the amount of coat with respect to the amount of pre-coat is obtained. Further, in Embodiment 3, a material having low charge amount imparting ability is used for the regulating blade, and hence, compared to the case of using the SUS blade of Embodiment 1, there is no risk in aggravating fog and the effect of suppressing solid image follow-up failure is obtained selectively.

Although a bias of −100 V was used as a bias to be applied to the regulating blade in Embodiment 3, the present invention is not limited thereto. A bias to be applied to the regulating blade can be used so that a potential difference between the developing roller and the regulating blade becomes a potential difference for urging toner from the regulating blade toward the developing roller.

Further, although the regulating blade having a volume resistivity of 1×10⁶ Ω·cm to 1×10⁹ Ω·cm obtained by the addition of an ionic electro-conductive agent is used in Embodiment 3, the effects of the present invention are also obtained in the case of using a regulating blade having a volume resistivity of 1×10³ Ω·cm to 1×10⁹ Ω·cm obtained by adding carbon as an additive to adjust a resistance.

Due to the configuration of Embodiment 3, even in the case where the VSP/VDR is decreased so as to suppress the degradation of toner, a pre-coat having a high toner charge amount unique to the “with” rotation can be taken in the abutment nip portion between the developing roller 42 and the regulating blade 44. Thus, a developing apparatus can be realized, in which the solid image follow-up failure and occurrence of fog are prevented, and the life is extended with high image quality.

### Embodiment 4

In Embodiment 4 of the present invention, there are described a configuration in which a stepped portion serving as a developer taking-in portion is provided in the distal end portion of the regulating blade, the stepped portion being formed into a shape so as to be getting away from the surface of the developing roller toward the upstream side in the rotation direction of the developing roller, and a configuration in which a slope portion serving as a developer taking-in portion is provided in the distal end portion of the regulating blade.

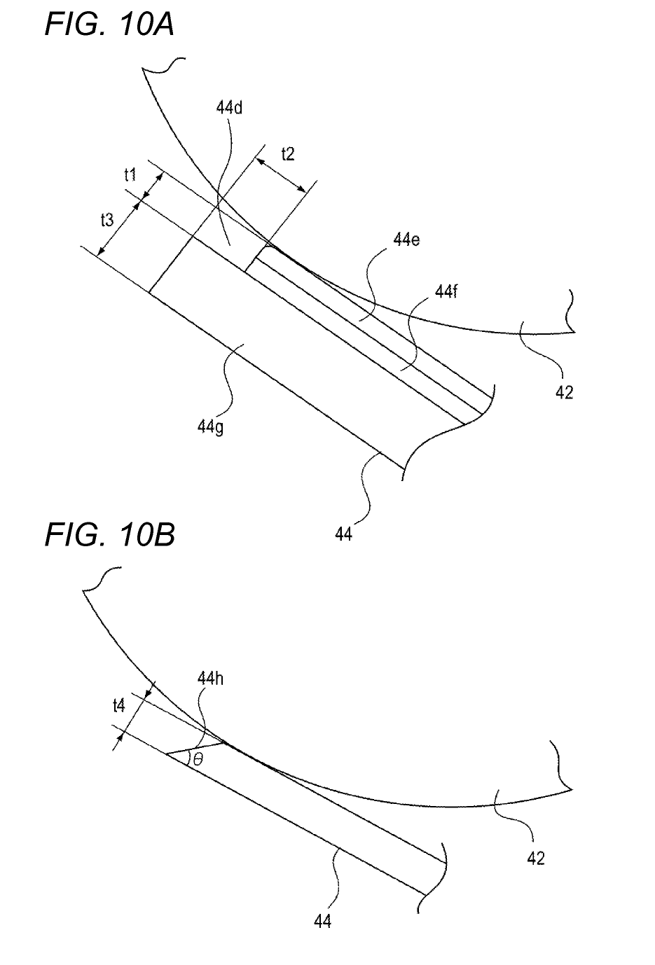

FIG. 10A illustrates a configuration example in which a stepped portion serving as a developer taking-in portion is provided in the distal end portion of the regulating blade. Further, FIG. 10B illustrates a configuration example in which a slope portion serving as a developer taking-in portion is provided in the distal end portion of the regulating blade.

The regulating blade 44 illustrated in FIG. 10A has a configuration in which a PET sheet is adhered to the rear side of the regulating blade 44 to provide a stepped portion 44d serving as a toner taking-in region in the distal end portion of the regulating blade 44. A double-sided tape 44f having a thickness of 0.10 mm is used on a side opposite to an abutment surface of a SUS blade 44e having a thickness of 0.1 mm with respect to the developing roller 42, and a PET sheet 44g having a thickness of 0.3 mm is adhered onto the double-sided tape 44f. The distal end portion of the PET sheet 44g protrudes by a predetermined amount toward the upstream side in the rotation direction of the developing roller 42 from the distal end portion of the SUS blade 44e. In this case, a protrusion amount t2 of the PET sheet 44g from the distal end of the SUS blade 44e is set to 1.5 mm. Further, an abutment position of the regulating blade 44 with respect to the developing roller is set so that an edge portion of the SUS blade 44e abuts on the developing roller 42. With such a configuration, the stepped portion 44d serving as a developer taking-in portion is formed in the distal end portion of the regulating blade 44.

Accordingly, a toner taking-in region having a size for improving solid image follow-up performance can be obtained. Then, by performing edge abutment at the abutment position of the SUS blade 44e which abuts on the developing roller 42, the functional effect similar to that of Embodiment 1 can be obtained in which a predetermined toner taking-in region is obtained stably, with the result that both the problems of fog and solid image follow-up failure can be solved.

In Embodiment 4, a thickness t1 of the SUS blade (SUS plate) 44e including the thickness of the double-sided tape 44f can be set to 0.1 mm to 0.2 mm, and a protrusion amount t2 of the PET sheet 44g from the distal end of the SUS blade 44e can be set to 0.5 mm to 2.0 mm. When the protrusion amount t2 is too small, an effective toner taking-in region cannot be obtained. When the protrusion amount t2 is too large, the distal end position of the PET sheet 44g is liable to change, which causes difficulty in forming a stable toner taking-in region. Further, a thickness t3 of the PET sheet 44g only needs to be set so that sufficient stiffness is obtained to form a stable toner taking-in region.

The regulating blade 44 illustrated in FIG. 10B has a configuration in which a slope portion 44h is formed by polishing the distal end of the regulating blade 44 to provide a toner taking-in region in the distal end portion. A thickness t4 of the regulating blade (SUS plate) 44 is set to 0.2 mm, and the distal end of the regulating blade is polished at a predetermined angle θ (45° in this case) to form the slope portion 44h serving as a toner taking-in region. Accordingly, a toner taking-in region having a size for improving solid image follow-up performance can be obtained. Further, an abutment range of the regulating blade 44, in which edge abutment is performed at the abutment position with respect to the developing roller 42, is large, and hence, the functional effect similar to that of Embodiment 1 is obtained in which a predetermined toner taking-in region can be obtained stably, with the result that both the problems of fog and solid image follow-up failure can be solved.

In Embodiment 4, the angle e of the distal end can be set to 20° to 70°. When the angle e of the distal end is too small, a difference from the body abutment configuration described in Embodiment 1 becomes smaller, and fog is liable to occur. When the angle e is too large, a toner taking-in region does not function well, and the effect of improving solid image follow-up performance cannot be obtained.

The thickness of the SUS blade (SUS plate) 44, the protrusion amount of the PET sheet 44g, and the angle e of the distal end in the developing apparatus of Embodiment are not limited to the above-mentioned ranges. The effects of the present invention are obtained by selecting preferred ranges in accordance with the configuration of a developing apparatus to be used.

Further, although a metallic SUS plate is used as a material for a portion which abuts on the developing roller 42 in Embodiment 4, the present invention is not limited thereto. For example, the effects of Embodiment 2 can be obtained by using a polyamide elastomer, polyamide, polyester, a polyester elastomer, polyester terephthalate, polyurethane, silicone rubber, a silicone resin, or a melamine resin.

Further, the effects of Embodiment 3 can be obtained by employing an electro-conductive blade material to apply a potential difference for urging toner from the regulating blade toward the developing roller.

Due to the configuration of Embodiment 4, even in the case where the VSP/VDR is decreased so as to suppress the degradation of toner, a pre-coat having a high toner charge amount unique to the “with” rotation can be taken in the abutment nip portion between the developing roller 42 and the regulating blade 44. Thus, a developing apparatus can be realized, in which the solid image follow-up failure and occurrence of fog are prevented, and the life is extended with high image quality.

### Other Embodiments

In the foregoing embodiments, image forming apparatus including a developing apparatus configured to develop a latent image formed on a photosensitive drum with developer are described in an illustrative manner. However, the present invention is not limited thereto. For example, the present invention is also effective in a process cartridge which includes a photosensitive drum and a developing apparatus (developing unit) serving as a process unit that acts on the photosensitive drum, and which is removably mounted on a main body of an image forming apparatus. As a process cartridge which can be removably mounted on a main body of an image forming apparatus, there may be given a process cartridge integrally including any one of a charging unit and a cleaning unit besides the photosensitive drum and the developing unit serving as a process unit which acts on the photosensitive drum.

Further, in the above-mentioned embodiments, a printer will be described in an illustrative manner as an image forming apparatus. However, the present invention is not limited thereto. For example, the image forming apparatus may be other image forming apparatus such as a copying machine and a facsimile machine, or other image forming apparatus such as a multifunctional peripheral combining the functions of the copying machine and the facsimile machine. When the present invention is applied to a developing apparatus to be used in the image forming apparatus, the effects similar to those of the present invention can be obtained.

According to the embodiments of the present invention, the developer which is carried and conveyed by the developer carrying member is taken in and held by the developer taking-in portion provided in the distal end portion of the developer regulating member. Therefore, even when the relative circumferential speed ratio between the developer carrying member and the developer feeding member is decreased so as to reduce the degradation of toner, the developing apparatus can be provided in which the solid image follow-up failure is prevented and the life is extended with high image quality.

While the present invention has been described with reference to embodiments, it is to be understood that the invention is not limited to the disclosed embodiments. The scope of the following claims is to be accorded the broadest interpretation so as to encompass all such modifications and equivalent structures and functions.

This application claims the benefit of Japanese Patent Application No. 2012-101859, filed Apr. 26, 2012, which is hereby incorporated by reference herein in its entirety.

What is claimed is:

1. A developing apparatus, comprising:
a developer carrying member configured to carry and convey developer;
a developer feeding member configured to feed the developer to the developer carrying member in abutment with the developer carrying member; and
a developer regulating member having a distal end portion directed toward an upstream side in a rotation direction of the developer carrying member, and configured to regulate a layer thickness of the developer carried on the developer carrying member in abutment with a surface of the developer carrying member,
wherein the developer carrying member and the developer feeding member rotate so that a surface of the developer carrying member and a surface of the developer feeding member move in a same direction in an abutment portion between the developer carrying member and the developer feeding member,
wherein the distal end portion of the developer regulating member has a developer taking-in portion formed into a shape away from the surface of the developer carrying member toward the upstream side in the rotation direction of the developer carrying member, and
wherein the developer taking-in portion is positioned on the upstream side in the rotation direction of the developer carrying member relative to an abutment position between the developer regulating member and the developer carrying member.

2. A developing apparatus according to claim 1, wherein the developer regulating member comprises, as the developer taking-in portion, an arc portion formed into the shape away from the surface of the developer carrying member toward the upstream side in the rotation direction of the developer carrying member.

3. A developing apparatus according to claim 1, wherein the developer regulating member comprises, as the developer taking-in portion, a stepped portion formed into the shape away from the surface of the developer carrying member toward the upstream side in the rotation direction of the developer carrying member.

4. A developing apparatus according to claim 1, wherein the developer regulating member comprises, as the developer taking-in portion, a slope portion formed into the shape away from the surface of the developer carrying member toward the upstream side in the rotation direction of the developer carrying member.

5. A developing apparatus according to claim 1, wherein the developer regulating member comprises an abutment surface which abuts on the developer carrying member, the abutment surface being made of a resin or an elastomer having a work function higher than a work function of a metal.

6. A developing apparatus according to claim 1, wherein the distal end portion of the developer regulating member is formed by coating an end portion of a support with a resin or an elastomer.

7. A developing apparatus according to claim 5, wherein the abutment surface of the developer regulating member, which abuts on the developer carrying member, has a volume resistivity of 1×10³ Ω·cm to 1×10⁹ Ω·cm.

8. A developing apparatus according to claim 6, wherein an abutment surface of the developer regulating member, which abuts on the developer carrying member, has a volume resistivity of 1×10³ Ω·cm to 1×10⁹ Ω·cm.

9. A developing apparatus according to claim 1, wherein the developer regulating member is in abutment with the developer carrying member so that the distal end portion is directed upward.

10. A developing apparatus according to claim 1, wherein the developer regulating member is supplied with a bias so that a potential difference between the developer carrying member and the developer regulating member becomes a potential difference for urging the developer from the developer regulating member toward the developer carrying member.

11. A process cartridge, which is removably mounted on a main body of an image forming apparatus, the process cartridge comprising:
an image bearing member configured to bear a latent image; and
a developing apparatus including:
a developer carrying member configured to carry and convey developer;
a developer feeding member configured to feed the developer to the developer carrying member in abutment with the developer carrying member; and
a developer regulating member having a distal end portion directed toward an upstream side in a rotation direction of the developer carrying member, and configured to regulate a layer thickness of the developer carried on the developer carrying member in abutment with a surface of the developer carrying member,
wherein the developer carrying member and the developer feeding member rotate so that a surface of the developer carrying member and a surface of the developer feeding member move in a same direction in an abutment portion between the developer carrying member and the developer feeding member,
wherein the distal end portion of the developer regulating member has a developer taking-in portion formed into a shape away from the surface of the developer carrying member toward the upstream side in the rotation direction of the developer carrying member, and
wherein the developer taking-in portion is positioned on the upstream side in the rotation direction of the developer carrying member relative to an abutment position between the developer regulating member and the developer carrying member.

12. A process cartridge according to claim 11, wherein the developer regulating member comprises, as the developer taking-in portion, an arc portion formed into the shape away from the surface of the developer carrying member toward the upstream side in the rotation direction of the developer carrying member.

13. A process cartridge according to claim 11, wherein the developer regulating member comprises, as the developer taking-in portion, a stepped portion formed into the shape away from the surface of the developer carrying member toward the upstream side in the rotation direction of the developer carrying member.

14. A process cartridge according to claim 11, wherein the developer regulating member comprises, as the developer taking-in portion, a slope portion formed into the shape away from the surface of the developer carrying member toward the upstream side in the rotation direction of the developer carrying member.

15. A process cartridge according to claim 11, wherein the developer regulating member comprises an abutment surface, which abuts on the developer carrying member, the abutment surface being made of a resin or an elastomer having a work function higher than a work function of a metal.

16. A process cartridge according to claim 11, wherein the distal end portion of the developer regulating member is formed by coating an end portion of a support with a resin or an elastomer.

17. A process cartridge according to claim 15, wherein the abutment surface of the developer regulating member, which abuts on the developer carrying member, has a volume resistivity of 1×10³ Ω·cm to 1×10⁹ Ω·cm.

18. A process cartridge according to claim 16, wherein an abutment surface of the developer regulating member, which abuts on the developer carrying member, has a volume resistivity of 1×10³ Ω·cm to 1×10⁹ Ω·cm.

19. A process cartridge according to claim 11, wherein the developer regulating member is in abutment with the developer carrying member so that the distal end portion is directed upward.

20. A process cartridge according to claim 11, wherein the developer regulating member is supplied with a bias so that a potential difference between the developer carrying member and the developer regulating member becomes a potential difference for urging the developer from the developer regulating member toward the developer carrying member.
